(19) United States
(12) Patent Application Publication
(10) Pub. No.: US 2009/0122728 A1
(43) Pub. Date: May 14, 2009

(54) SYSTEMS, METHODS, NETWORK ELEMENTS AND APPLICATIONS FOR MANAGEMENT OF PROMOTIONAL CAMPAIGNS

(75) Inventors: Janne Aaltonen, Turku (FI); Mika Muukkonen, Turku (FI); Pauli Kuosmanen, Kangasala (FI); Janne Pollanen, Lieto As. (FI); Jouni Kemppainen, Vantaa (FI); Sami Saru, Turku (FI)

Correspondence Address: BARNES & THORNBURG LLP, 750-17TH STREET NW, SUITE 900, WASHINGTON, DC, 20006-4675, US

(73) Assignee: CVON Innovations Limited, London (GB)

(21) Appl. No.: 12/212,987

(22) Filed: Sep. 18, 2008

Related U.S. Application Data
(60) Provisional application No. 60/977,267, filed on Oct. 3, 2007.

(51) Int. Cl. H04L 12/16

(52) U.S. Cl. 370/259

(57) ABSTRACT

Mechanisms and methodologies are provided that enable marketing, advertising and customer relations management campaign implementation that includes a combination advertising, marketing and direct marketing strategies implemented via a combination of communications via Voice over Internet Protocol (VoIP) and other communication networks in a manner that establishes a long-term, engaging relationship between a customer or consumer and a promotion company or advertiser.

The invention relates in general to marketing, advertising and customer/consumer relationship management campaigns. In particular, the invention relates to methods, systems and software for supporting or implementing such campaigns directed to individuals having Voice over Internet Protocol (VoIP) capability and/or communication devices that communicate via one or more communication networks, as specified in the independent claims.

### BACKGROUND OF THE INVENTION

VoIP service enables voice communication carried over Internet networks. VoIP is also conventionally referred to as Internet Protocol (IP) Telephony, Internet telephony, Broadband telephony, Broadband Phone and Voice over Broadband. A typical arrangement for a VoIP service is to use a dedicated VoIP client in a user's terminal, which may be, for example, a personal computer. The introduction of smart phones (i.e., a cellular phone that can connect to the Internet for tasks like Web browsing and sending and receiving e-mail) has also enabled making of VoIP calls using mobile devices.

In fact, the overwhelming popularity of mobile devices such as smart phones has opened up the possibility of using mobile devices and related communication infrastructure as a media for providing what may be referred to as “mobile marketing” to potential consumers. Mobile marketing involves and relates to marketing and advertising via mobile devices, e.g., mobile phones, smart phones, and Personal Data Assistants (PDAs), or any other computer device configured to be able to receive or send data wirelessly, receiving promotional content, e.g., marketing and/or advertising content in the form of, e.g., text, audio, video or some combination thereof associated with a particular product, service or combination thereof.

Mobile marketing is considered by advertisers as the next new channel to directly reach potential consumers. Mobile marketing enables advertisers to directly reach individual consumers in a targeted way. This is because the nature of mobile media is personal, in that mobile devices are generally used by a particular individual rather than a group of individuals. Further, mobile media is, by definition, mobile, which offers a transportable mechanism for exposing potential consumers to advertising content. Moreover, because mobile media is “always on,” advertisers are not constrained by the need to make a connection in order to deliver advertising content to a user's device because a connection is always established with a user's mobile device (provided the mobile device is in range of an available communication network). As an additional benefit of mobile media as an advertising mechanism, mobile media enables groups of individuals to form wherein the group members communicate actively with each other. As a result, these characteristics combined with social networks-based marketing approach of the Internet may form a very powerful base to execute marketing strategies.

However, executing such marketing strategies and promotional campaigns is difficult when what may be thought of as “mobile marketing” functionality is to be delivered to individuals via one or more networks with differing technical and operational functionality and requirements, particularly when, VoIP networks and cellular networks are involved and individuals can receive promotional content via VoIP networks and/or various other communication networks including Publicly Switched Telephone Networks (PSTNs), cellular networks, etc.

### SUMMARY OF THE INVENTION

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with at least one embodiment of the invention, methodologies and mechanisms are provided that enable methods, systems and software for supporting or implementing marketing, advertising and/or customer/consumer relations campaigns directed to individuals having Voice over Internet Protocol (VoIP) capability and/or mobile devices that communicate via one or more communication networks, as specified in the independent claims. This is achieved by a combination of features recited in each independent claim. Accordingly, dependent claims prescribe further detailed implementations of the present invention.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates an advertising environment wherein embodiments of the invention may be utilized.

FIG. 2 illustrates additional details included in an advertisement management system provided in accordance with at least one embodiment of the invention.

FIGS. 3-4 each illustrate examples of method operation performed in conjunction with at least one embodiment of the invention.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

In general, marketing and advertising activities can be divided into four categories: mobile Customer Relations Management (CRM), mobile marketing, mobile advertising, and mobile direct advertising. CRM involves a combination of mobile advertising, mobile marketing and mobile direct marking (each explained herein) in a manner that establishes a long-term, engaging relationship between a customer or potential customer (i.e., consumer) and a promoting company such as an advertiser of one or more products and/or services.

For example, mobile marketing involves the systematic planning, implementation and control of a mix of business activities intended to bring together buyers and sellers for the mutually advantageous exchange or transfer of products or services where the primary point of contact with the potential consumer is via their mobile device. To the contrary, mobile advertising may be thought of more narrowly as the paid, public, non-personal announcement of a persuasive message by an identified sponsor (i.e., an advertiser), the non-personal presentation or promotion by a firm of its products to its existing and potential customers where such communication is delivered to a mobile phone or other mobile device. Examples of mobile advertising would include: Wireless Application Protocol (WAP) and Web banner advertisements, mobile search advertising, mobile video bumpers, and interstitial advertisements.

Mobile direct marketing differs from mobile marketing typically in that direct marketing involves advertising content being delivered to a mobile device on an individual basis. Accordingly, examples of mobile direct marketing include the sending of Short Messaging Service (SMS), Enhanced Messaging Service (EMS), Multimedia Messaging Service (MMS) or WAP push messages, Bluetooth messaging and other marketing to mobile devices.

Such direct marketing often uses text and picture messaging. MMS, also known as picture messaging, is a widely used service with mobile phone users. Picture messaging refers to the sending of an image, e.g., a photograph produced by a mobile phone, to another mobile phone or to a server or electronic-mail account. Conventionally, the images are sent in some predetermined picture format, e.g., Joint Picture Expert Group (JPEG). In addition to pictures, MMS messages might compose of video, audio, hypertext, links, etc.

However, a problem in executing such marketing strategies results when mobile advertising functionality is to be integrated into one or more communication networks with differing technical and operational functionality and requirements. This is a particular problem when, for example, cellular, that is CDMA or GSM, are available for distributing promotional content as well as VoIP networks. This is because communication via VoIP is initiated and managed in a different manner than for communication via PSTN or a cellular network.

Simply put, VoIP is the routing of voice conversations over the Internet or through any other IP-based network. This routing is the process of selecting paths in one or more networks along which to send data or physical traffic. Companies providing VoIP service are commonly referred to as “VoIP providers,” and protocols which are used to carry voice signals over an IP network are commonly referred to as “VoIP protocols.” Thus, VoIP providers such as Vonage™ or Skype™ provide the capability to initiate and receive voice calls via VoIP; these service providers utilize proprietary closed VoIP networks. In addition to such proprietary systems, various industry standards also enable interoperability of VoIP networks. One example of such a standard is the Internet Engineer Task Force (IETF) proposal RFC3261, “SIP: Session Initiation Protocol,” (SIP) which may be used for signalling purposes between VoIP clients which are initiating, carrying on or terminating a VoIP session, which is the voice communication between a plurality of VoIP clients.

Products such as VoIP phones (hardware that provides a handset and software sufficient to provide a VoIP client recognized by a VoIP network) can integrate with other services available over the Internet, including video conversation, message or data file exchange in parallel with the conversation, audio conferencing, managing address books and passing information about whether other users are available online to interested parties.

However, while POTS and mobile phone networks may share common global standards which allocate and identify specific telephone lines, there is no widely adopted similar standard for VoIP networks. Further, although some VoIP networks allocate an telephone number that can be used for VoIP as well as incoming/external calls, there are often different, incompatible schemes when calling between VoIP providers which use provider specific short codes.

As a result, telecommunications companies are developing IP Multimedia Subsystems (IMSs) which are anticipated to merge Internet technologies with the mobile world, using a pure VoIP infrastructure. As a result, in theory, telecommunications companies will be able to upgrade their existing systems while embracing Internet technologies such as the Web, electronic mail, Instant Messaging (IM), presence, and video conferencing as well as allow existing VoIP networks to interface with conventional PSTN and mobile devices. Therefore, the convergence of VoIP technology and other types of voice communication networks is increasing.

Moreover, because VoIP is location independent (only an Internet connection is needed to get a connection to a VoIP provider), mobile phone makers providing smart phones are now developing “dual mode” telephone sets, which allow for the seamless handover between a cellular network and a WiFi network.

VoIP Mobile, or Mobile Voice over Internet Protocol, is the application of VoIP technology to mobile devices. VoIP Mobile requires a mobile device that supports, at a minimum, high speed Internet Protocol (IP) communications. This may be provided, e.g., using Voice over Wi-Fi or VoWi-Fi, but the same protocols (e.g., SIP) can be used over any broadband IP-capable wireless network connection such as the various 3G standards or potentially WiMAX.

Mobile VoIP relies on two main technologies: the Unlicensed Mobile Access (UMA) Generic Access Network, designed to allow VoIP to run over a GSM cellular backbone; and SIP, the standard used by most VoIP services.

Similarly, MoIP, or mobile communications over IP, is the mobilization of peer-to-peer communications including chat and talk using IP via standard mobile communications applications including 3G, GPRS and Wifi. Unlike mobile VoIP, MoIP is not a VoIP client made accessible from mobile devices or a switchboard application using VoIP in the background. Rather, MoIP is a native mobile application on users' mobile devices and used to conduct talk and chat over the internet connection as its primary channel.

Regardless of the various implementations for combining IP, VoIP and cellular and PSTN technology, the resulting combination of technologies increases the number of different distribution channels for marketing, advertising and CRM. As a result, there is also an increasing need for technology for developing and implementing mobile marketing strategies such as CRM to be implemented over a variety of distribution channels.

Moreover, the availability of communicating with consumers/customers via VoIP rather than via other communication networks, such as PSTN and cellular networks, reduces the cost of implementing CRM campaigns because IP and VoIP is typically less expensive than voice communication via other networks, e.g., mobile networks. For example, VoIP in-network calls may be made for free or at a reduced fee.

Therefore, effective execution of marketing strategies in an environment where customers and consumers have access to VoIP, cellular and PSTN networks requires management of differing technical and operational functionality and requirements. This is particularly true because promotional content may be in the form of SMS, IM, MMS, electronic mail, voice data, video, text, etc. However, by utilizing VoIP, to communicate with consumers/customers reduces the cost of such strategies.

However, effective distribution of such promotional content via VoIP requires complex and pervasive monitoring and analysis of customer/consumer capabilities and connections with one or more communication networks including VoIP and cellular.

Thus, in accordance with at least one embodiment of the invention, methodologies and mechanisms are provided that enable marketing, advertising and CRM campaign implementation that includes a combination advertising, marketing and direct marketing strategies implemented via a combination of communications via VoIP and other communication networks in a manner that establishes a long-term, engaging relationship between a customer (or a consumer, which is merely a potential customer) and a promotion company or advertiser.

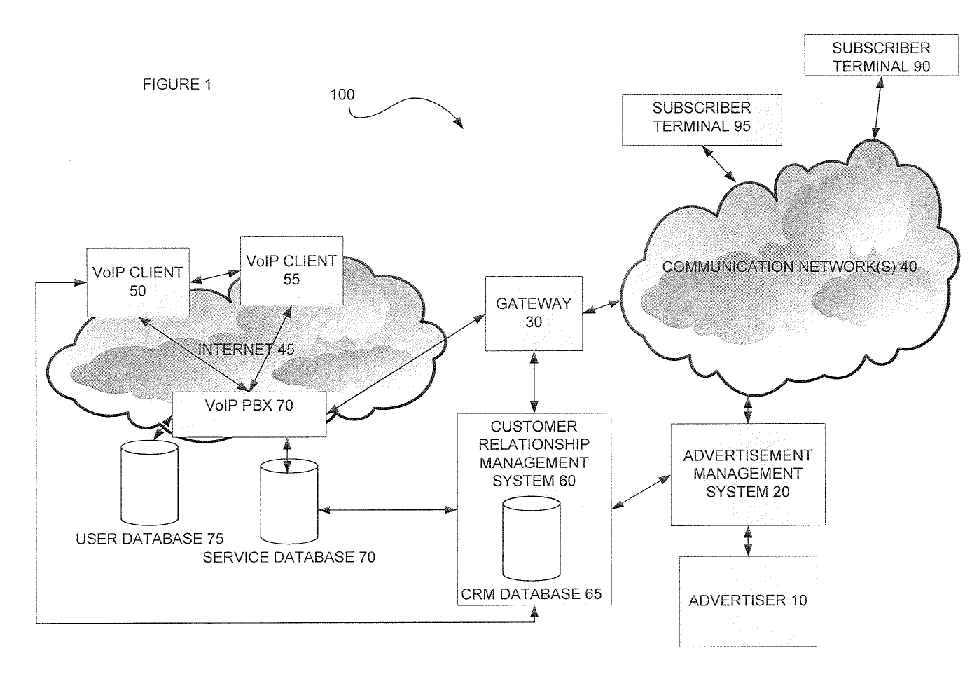

With this understanding of one area of the utility of embodiments of the invention in mind, a description of the architecture and operation of various invention embodiments is now provided. FIG. 1 illustrates an advertising environment wherein embodiments of the invention may be utilized. Embodiments of the invention may be utilized in environment 100 to provide mobile marketing which reaches a plurality of consumers/customers via a plurality of VoIP clients 50, 55 and/or subscriber terminals 90, 95 via a plurality of different types of networks, e.g., Internet 45 and one or more communication networks 40.

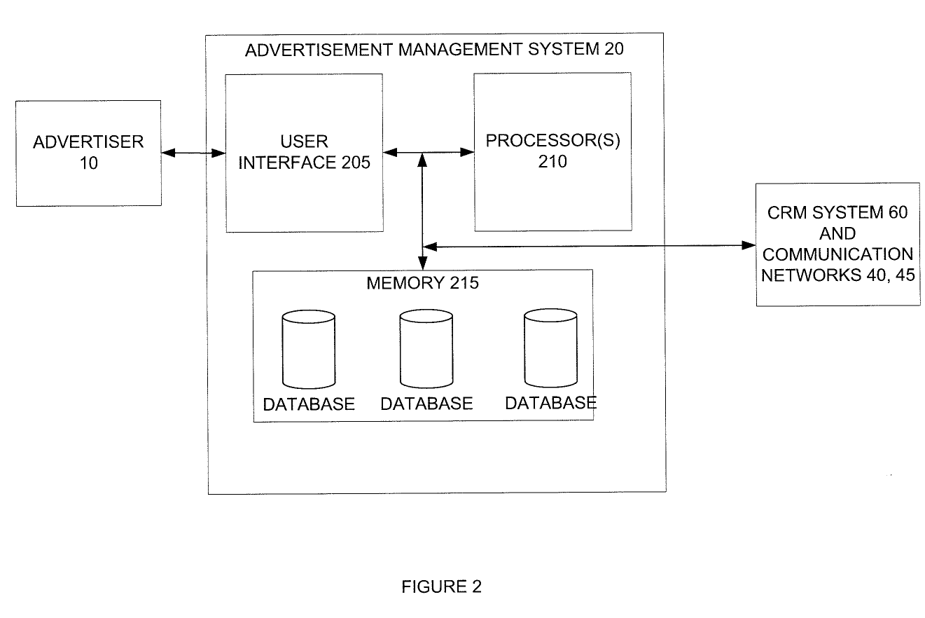

As illustrated in FIG. 1, an advertiser 10 (which may be an advertiser, advertising firm, media agency, operator, consultancy company, promotion company or other similar entity interested in implementing, managing or determining the efficacy of a marketing or advertising campaign) may access an Advertisement Management System (AMS) 20 (also illustrated in further detail in FIG. 2) to manage and control distribution of promotional content in connection with one or more marketing, advertising and/or CRM campaigns.

The advertiser 10 may reserve, program, and/or book a campaign via a user interface (explained further with reference to FIG. 2 and implemented as, for example, a web interface) for AMS 20. Further, the advertiser 10 may also define a set of rules governing and related to the delivery of promotional content to a plurality of users (via subscriber terminals 90, 95 and/or VoIP clients 50, 55).

As part of such a campaign, promotional content may be distributed to the one or more of the plurality of subscriber terminals 90, 95, which may be, for example, mobile devices or other devices capable of sending and receiving data and text messages and outputting such messages to the device users. Further, the promotional content may be distributed to one or more of the plurality of VoIP clients 50, 55. Such promotional content may include information in the form of data, text, pictures, audio, video, HyperText Markup Language (HTML), eXtensible Markup Language (XML), eXtensible HyperText Markup Language (XHTML). The advertiser 10 may also indicate instructions and/or rules indicating what, when and how to send promotional content, details regarding which users should receive promotional content (e.g., characteristics of device users included in a target group or groups for the campaign), in which format (e.g., SMS, IM, electronic mail, MMS, WAP Push, Web pages, digital object, etc.), a target price level for the advertising campaign, demographics of the target audience, duration of the campaign, etc.

Each of the subscriber terminals 90, 95 can be implemented as a mobile phone, lap top, PDA, multimedia computer, smart phone, etc. Accordingly, although not illustrated, it should be understood that a subscriber terminal 90, 95 may include a processor connected to a user interface, computer readable memory and/or other data storage and a display and/or other output device. The subscriber terminal 90, 95 may also include a battery, speaker and at least one antenna. The user interface may further include a keypad, touch screen, voice interface, one or more arrow keys, joy-stick, data glove, mouse, roller ball, touch screen or the like.

Accordingly, computer executable instructions and data used by a processor included in a subscriber terminal 90, 95 and other components within a mobile device may be stored in the computer readable memory included in the subscriber terminal 90, 95. Further, the memory may be implemented with any combination of read only memory modules or random access memory modules, optionally including both volatile and non-volatile memory. Further, software may be stored within the memory and/or storage to provide instructions to the subscriber terminal's processor for enabling the mobile device to perform various functions. Alternatively, some or all of the device computer executable instructions may be embodied in hardware or firmware (not illustrated).

Terminals 90, 95 may have capability to communicate with one or more different types of communication networks and have messaging capabilities including, e.g., a SMS client, electronic mail client or MMS client embedded in the terminal. Terminals 90, 95 may also include a browser (not shown) configured to access Web and/or WAP services.

Similarly, VoIP clients 50, 55 may be implemented as part of a mobile phone, lap top, PDA, desktop or multimedia computer, smart phone, etc. Accordingly, although not illustrated, it should be understood that VoIP clients 50, 55 may include a processor connected to a user interface, computer readable memory and/or other data storage and a display and/or other output device. Accordingly, computer executable instructions and data used by a processor included in the VoIP client may be stored in the computer readable memory included in the hardware associated with the VoIP client. Further, the memory may be implemented with any combination of read only memory modules or random access memory modules, optionally including both volatile and non-volatile memory. Further, software may be stored within the memory and/or storage to provide instructions to the processor for enabling performance of various functions. Alternatively, some or all of the device computer executable instructions may be embodied in hardware or firmware (not illustrated).

Regardless, like terminals 90, 95, VoIP clients 50, 55 may have the capability to communicate with one or more different types of communication networks. Thus, although a VoIP client 50, 55 may communicate via IP (electronic mail or VoIP), it should be understood that the VoIP client may have other messaging capabilities including, e.g., a SMS client, or MMS client. The VoIP clients 50, 55 may also include a browser (not shown) configured to access Web and/or WAP services. Thus, the term “VoIP client,” as that term is used throughout this application includes, but is not limited to, any terminal capable of providing VoIP services, for example, a mobile phone with VoIP software, a personal computer or laptop with VoIP software and/or related hardware.

Moreover, it should be understood that, in accordance with at least one embodiment of the invention, the subscriber terminals 90, 95 and VoIP clients 50, 55 may be implemented in single devices. As a result, the functionality provided by a subscriber terminal 90 may be combined with the functionality provided by VoIP client 50; accordingly, such a single device may enable communication with a single consumer/customer/user via either the Internet 45 or one or more communication network(s) 40. As a result, in accordance with at least one embodiment of the invention, advertisers may contact the consumer/customer/user via IP, e.g., VoIP, at a less expensive cost than may be required for such communication via communication network(s) 40.

The one or more communication networks 40 may include any type of communications network including but not limited to a second Generation (2G) network, a 2.5 Generation network, a third Generation (3G) network utilizing GSM, Wideband Code Division Multiplex Access (WCDMA), CDMA, or Time Division Multiplex Access (TDMA), GPRS, Universal Mobile Telephone System (UMTS), etc. Network(s) 40 can also be implemented as a combination of two or more technologies i.e., a hybrid network. Further, communication network(s) 40 may also include generic Internet access using one or more transport methods.

Further, the one or more communication networks 40 may also include Local Area Networks (LANs), such as Wireless Local Area Networks (WLAN), BlueTooth (BT) and optionally utilize one or more other technologies, such as WiMax (WorldwideInteroperability for Microwave Access). Communication via the one or more communication networks 40 may be implemented by broadcasting over cellular, broadcasting over DVB-H (Digital Video Broadcasting-Handhelds), ISDB-T (Terrestrial Integrated Services Digital Broadcasting) or DMB (Digital Multimedia Broadcasting).

The one or more communication networks 40 can also include any other type of network of interconnected devices or device networks, e.g., interconnected computers or computer networks. Accordingly, it should be understood that the one or more communication networks 40 can also be a combination of a plurality of different types of networks forming one or more hybrid networks.

Although not shown, the communication network(s) 40 may also include one or more network elements, e.g., home location registers, call detail records, SMS centers, MMS centers, WAP gateways, etc. Additionally, the communication network(s) 40 may include or be implemented to communicate with various additional components, e.g., a billing system (not shown), base stations (not shown) and other elements, interfaces and functions conventionally understood to be of use in the operation and provision of a communication network(s). Further, the one or more communication networks 40 may further include one or more base stations or wireless communications station (not shown) installed at fixed locations and used to communicate as part of either a push-to-talk two-way radio system or a wireless telephone system, for example, cellular, CDMA or GSM.

Gateway 30 may be configured to provide two way communication between the Internet 45 and communication network(s) 40 as the gateway 30 may be configured to control traffic to and from communication network(s) 40 and the Internet 45. Thus, gateway 30 acts may be conceptually thought of as a network point that acts as an entrance to these networks. The gateway 30 may be implemented as or include, a proxy server or firewall server, router and/or switch (not shown).

Gateway unit 30 may be implemented to enable implementation of Internet-based VoIP services within the cellular infrastructure provided within communication network(s) 40. Thus, the gateway unit 30 may be configured to convert a VoIP call to a conventional cellular call; this functionality may be necessary because some cellular networks are optimized for voice calls.

The AMS 20 can be operationally coupled to the communication network(s) 40 either directly or via the CRM system 60 and the gateway 30. Communication between the CRM 60 and the communication network(s) 40 and the Internet 45 may be performed using gateway 30. Moreover, communication network(s) 40 may be implemented as, include or be connected or coupled to the Internet 45 via gateway 30 to provide access to various Internet-implemented services. Such services may include information, products, subscription services, etc.

As illustrated in FIG. 1, the network(s) 40 may include or be configured to provide communication functionality among a plurality of subscriber terminals 90, 95 which may be connected or coupled to communication network(s) 40 via, for example, one or more base stations (not shown). Additionally, communication sessions may occur between a plurality of subscriber terminals 90, 95 or a subscriber terminal 90, 95 and another entity, for example, VoIP clients 50, 55. As a result, the subscriber terminal 90, 95 may utilize elements, for example, network elements such as a WAP gateway (not shown) for WAP browsing or use of packet radio connections in the form of GPRS to access Internet 45 and Internet implemented services via gateway 30, e.g., Internet access using a web browser in, e.g., a subscriber terminal and an IP connection.

The CRM 60 may be configured to coordinate and/or implement distribution of promotional content in coordination with the advertisement management system 20. As illustrated in FIG. 1, the CRM 60 may include a CRM database 65 which may include, data related to distributing promotional content to one or more recipients (e.g., VoIP clients 50, 55, subscriber terminals 90, 95, etc.). It should be appreciated that the functionality of the CRM 60 and the AMS 20 may be implemented together or separately and/or remotely in any number of variations so as to provide the ability to control the distribution of promotional content to consumer/customers in a manner requested by one or more advertisers.

Thus, in accordance with at least one embodiment of the invention, the AMS 20 may be configured to operate as a mechanism for receiving content and instructions on distributing content to consumer/customers, whereas the CRM 60 may be configured to interact with the AMS 20 to receive such content and manage the delivery of such content via the Internet 45 and communication network(s) 45 via gateway 30.

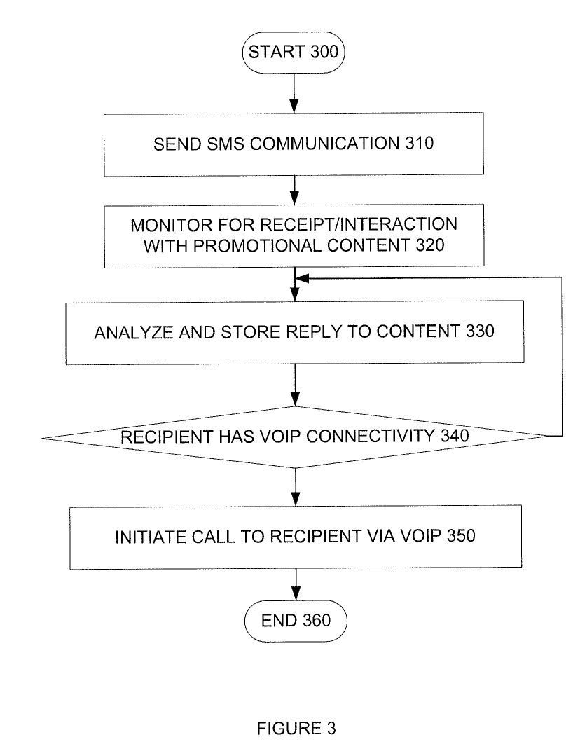

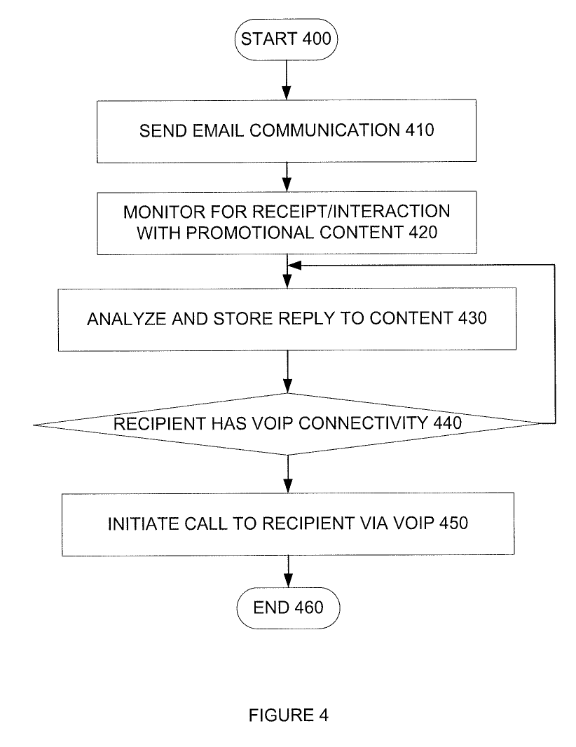

FIG. 2 illustrates one example of the components of the AMS 20 in more detail. Preferences, settings, and promotional content and/or other rules of distributing promotional content may be stored in memory 215. Promotional content may be commercial, e.g., product or service promotion or non-commercial messages such as general information services. Additional details regarding rules for distributing promotional content will be explained with reference to FIGS. 3-4 below.

Once an advertiser has provided data indicating what, when and how promotional content is to be distributed (e.g., the content, format and timing of content delivery) in connection with a marketing, advertising or CRM campaign, the information may be used to deliver the promotional content via the one or more communication networks 40 to one or more subscriber terminals 90, 95 and/or via the Internet 45 to one or more VoIP clients 50, 55 using the CRM 60 and AMS 20. The CRM 60 may communicate with the VoIP clients 50, 55 via the gateway 30, which in turn may communicate via a VoIP Private Branch eXchange (PBX)/VoIP proxy 70. That VoIP PBX 70 may be connected or coupled to the Internet 45. As a result, one or more VoIP clients 50, 55 may be coupled to the VoIP PBX 70 (and the CRM 60) via the Internet 45.

The VoIP PBX 70 may be implemented in various alternative ways, for example, as a telephone exchange that serves a particular business, office or subset of service subscribers, or one that a common carrier or telephone company operates for many businesses or for the general public. Moreover, the VoIP PBX 70 may support packet switched networks for data as well as supporting VoIP telephone calls via the Internet as a global delivery system. Thus, it should be understood that the gateway 30 may include but is not limited to one or more Foreign eXchange Stations (FXSs) and/or Foreign eXchange Office (FXO) adapters to enable communication from VoIP clients with one or more communication networks 40, e.g., cellular or PSTN.

Thus, it should be understood that the gateway 30 may include but is not limited to one or more Foreign eXchange Stations (FXSs) and/or Foreign eXchange Office (FXO) and/or Primary Rate Interface (PRI) and/or Basic Rate Interface (BRI) adapters to enable communication from VoIP clients with one or more communication networks 40, e.g., cellular, PSTN or ISDN.

As mentioned above, the CRM system 60 may be configured to manage and store data used in the management and delivery of promotional content to one or more VoIP clients (e.g., 50, 55) and/or one or more subscriber terminals 90, 95. Thus, the CRM system 60 may include, for example, one or more databases 65 including customer records and data indicating relationship history such as orders, offers, and customer information, e.g., IP addresses, customer phone numbers, addresses, etc.

For example, in a SIP-based implementation, VoIP clients 50, 55 may communicate with VoIP PBX 70, which maintain and store data indicating the network locations of the VoIP clients 50, 55 in one or more of the databases 70, 75. Thus, as a VoIP client 50 attempts to initiate a call to VoIP client 55, VoIP client 50 may send a SIP-based message to the VoIP PBX 70. If VoIP client 55 is resident in the VoIP provider's network, then the VoIP provider's VoIP PBX 70 may respond to the SIP-based message by returning an IP address for the recipient VoIP client 55 to the initiating VoIP client 50. Subsequently, the VoIP clients 50, 55 may commence communication via a VoIP session.

Similarly, the CRM 60 may communicate with VoIP clients 50, 55 provided that the VoIP PBX 70 confirms that the clients are resident in the VoIP provider's network and, therefore, able to receive promotional content, e.g., a phone call via VoIP. In doing so, the CRM 60 may communicate with one or more service databases 70 for providing various services to VoIP clients 50, 55 to obtain information about those clients including an IP address for use in communicating with the clients via VoIP. Moreover, the CRM 60 may also communicate with one or more user databases 75 for the same and other purposes.

Such service databases 70 may be maintained for storing service specific parameters; for example, services provided to VoIP clients 50, 55 over the Internet 45 including, e.g., VoIP services, content or information services, etc. Likewise, user databases 75 may be maintained to store user information, for example, in connection with or as part of providing one or more services such as VoIP or other communication services via VoIP PBX 70.

As illustrated in FIG. 2, the AMS 20 may include one or more processors 205 operationally coupled to a user interface 210, computer readable memory and/or other data storage 215. Accordingly, computer executable instructions and data used by the processor(s) 205 and other components within the AMS 20 may be stored in the computer readable memory included the AMS 20. Further, software may be stored within the memory and/or storage 215 (coupled to the processor(s) 205 and user interface 210) to provide instructions to the AMS components for enabling the system 20 to perform various functions.

For example, the AMS 20 may be configured to receive promotional content (e.g., audio, video, text, graphics, font type, font color, etc.) and format of the advertising content (e.g., MMS, EMS, SMS, WAP push, etc.) associated with marketing and/or advertising campaigns as well as other details regarding distribution of such promotional content via the user interface 210. Subsequently, that information may be stored in one or more databases included in the computer readable memory and/or other data storage 215. Accordingly, the user interface 210 may be configured to enable an advertiser 10 or other entity to interact with components of the AMS 20 as well as other systems coupled to the system 20 to manage and control distribution of promotional content and analysis of responses thereto as part of one or more marketing, advertising or customer relations campaigns. Accordingly, the user interface 210 may be implemented as a web-based user interface provided by software stored in the memory 215 or running on one or more servers associated with or supporting the AMS 20.

The memory 215 may include one or more databases configured to store promotional content, advertiser preferences for distributing promotional content, an archive of promotional content previously sent to a plurality of users and their respective responses to such advertising content as well as the type of promotional content, rules for selecting promotional content for distribution content, etc. Additionally, the memory 215 may also include one or more databases for storing actual promotional content and related distribution parameters for use in distributing the promotional content in connection with campaigns.

It should be understood that memory 215 may include many databases that separately include, for example, user profile information (including information about VoIP clients and/or subscriber terminals), promotional content, archive data, etc. or some combination or all of this information and data may be included in a single database.

In accordance with at least one embodiment of the invention, matching promotional content may also or alternatively be selected by various other schemes, e.g., combining device user profiles (which may indicate, for example, information about the recipient's geographic location, demographic information including age, gender, interests, etc) and preferences with advertisers' target profiles (e.g., demographic information provided by an advertiser regarding target audience for promotional content and delivery preferences). In accordance with at least one embodiment of the invention, matching promotional content may also or alternatively be selected by a round robin scheme, first reserve first serve, randomly etc.

As explained above, in accordance with at least one embodiment of the invention, the CRM system 60 may act individually or in cooperation with the AMS 20 to distribute promotional content. Such promotional content may be as described above and also may include voice data communicated to a consumer/customer/user either via a recorded message or by an individual. Further, it should be appreciated that promotional content may include interactive functionality or elements that enable remote detection of when and how a user has interacted with the promotional content, e.g., when a corresponding electronic mail, SMS, IM, or MMS message has been opened, viewed, or responded to.

FIG. 3 illustrates an example of operations performed in conjunction with initiating transmission of promotional content that includes an SMS advertisement to a VoIP user. As illustrated in FIG. 3, such operations begin at 300, and control proceeds to 310 at which an SMS message that includes promotional content is generated and transmitted to a VoIP user. Control then proceeds to 320 at which monitoring is performed for receipt of an indication that the promotional content has been received by the recipient and/or that the recipient of the promotional content has interacted with one or more elements of the promotional content. Such an indication may be received either directly from the recipient of the promotional content, e.g., the VoIP client included in a personal computer or mobile terminal, or indirectly via, for example, an advertisement management system (such as the AMS illustrated in FIGS. 1 and 2). Thus, for example, when the SMS message is read by the recipient, a reply may be generated and transmitted by a software application included in the recipient's subscriber terminal or VoIP client. Such a reply may be generated and transmitted automatically upon receipt or interaction with the promotional content.

Control then proceeds to 320, at which the reply is analyzed and the contents of the reply stored. In accordance with at least one embodiment of the invention, such a reply may include data sufficient for, e.g., the CRM system 60 illustrated in FIG. 1, to monitor subsequent activities of the subscriber terminal and/or VoIP client in one or more communication networks (including, for example, the communication network (40) and/or the Internet 45 illustrated in FIG. 1). Thus, when control proceeds to 330, the state of the promotional content recipient's VoIP client is monitored to determine when it is on or off-line. When it is determined that the promotional content recipient's VoIP client is on-line at 340, a call (for example, a VoIP call) is initiated to the recipient of the promotional content to convey additional promotional content via an audio message or to contact the promotional content recipient for by a marketing representative or the like. As long as the recipient's VoIP is off-line, control returns to 330, at which the recipient's VoIP client continues to be monitored. Following, 340, control proceeds to 350, at which the operations end.

FIG. 4 illustrates another example of operations performed in conjunction with initiating transmission of promotional content included in an electronic mail message to a VoIP user. As illustrated in FIG. 4, such operations begin at 400, and control proceeds to 410 at which promotional content included in an electronic mail message is generated and transmitted to a VoIP user. Control then proceeds to 420 at which monitoring is performed for receipt of an indication that the promotional content has been received by the recipient and/or that the recipient of the promotional content has interacted with one or more elements of the promotional content. Such an indication may be received either directly from the recipient of the promotional content, e.g., in an electronic mail message from a personal computer or mobile terminal of the user. Alternatively, the indication may be sent indirectly via, for example, an advertisement management system (such as AMS 20 illustrated in FIG. 1), from a third party (e.g., a web site or web host provider for advertiser 10 illustrated in FIG. 1, when the promotional content sent was specific to that advertiser). Further, or alternatively, when the electronic mail message is read by the recipient, a reply may be generated and transmitted by a software application included in the recipient's subscriber terminal or VoIP client; such a reply may be generated and transmitted automatically upon receipt or interaction with the promotional content.

Control then proceeds to 430, at which the reply is analyzed and the contents of the reply stored. In accordance with at least one embodiment of the invention, such a reply may include data sufficient for, e.g., the CRM system 60 illustrated in FIG. 1, monitoring of subsequent activities of the subscriber terminal and/or VoIP client in one or more communication networks (including, for example, the communication network (40) and/or the Internet 45 illustrated in FIG. 1). Thus, when control proceeds to 440, the state of the promotional content recipient's VoIP client is monitored to determine when it is on or off-line. When it is determined that the promotional content recipient's VoIP is on-line at 450, a VoIP call or mobile call is initiated to the recipient of the promotional content. As long as the recipient's VoIP is off-line, control returns to 440, at which the recipient's VoIP client continues to be monitored. However, following, 450, control proceeds to 460, at which the operations end.

Although FIGS. 3 and 4 illustrate an initial contact with a recipient of promotional content via SMS and electronic mail respectively, it should be understood that an initial presentation of promotional content may be performed via SMS, MMS, electronic mail, Instant Messaging (IM), via the World Wide Web, or any other alternative manner which enables the transmission and receipt of data that enables follow up interaction to occur via one or more networks, e.g., a VoIP network. As a result of the ability to determine and monitor a VoIP client's presence in a VoIP network, promotional content follow up calls may be placed used VoIP, thereby reducing the cost associated with an ongoing campaign such as a CRM campaign. Moreover, the ability to determine when a promotional material recipient has read or interacted with promotional content and the ability to monitor the VoIP client's presence in a VoIP network, enables the timing of a VoIP call to the VoIP client just when a customer/consumer/user associated with the VoIP client has just been exposed to or interacted with associated or related promotional content.

It should be understood that some or all of the operations illustrated in FIGS. 3-4 may be performed by, for example, a CRM system (such as CRM system 60 illustrated in FIG. 1) acting individually or in cooperation with an AMS (such as AMS system 20 illustrated in FIGS. 1 and 2). Various parameters and preference rules are analyzed by the CRM system to determine when and how to contact a recipient of promotional content via VoIP (as illustrated in FIGS. 3-4). For example, based on the information known about the user, the CRM can determine whether to attempt a call to a mobile or landline phone number, a VoIP address or something else.

In accordance with at least one embodiment of the invention, parameters utilized by the CRM system/AMS system may enable initiating follow up calls depending on the moment when a promotional content recipient has replied to the promotional content or interacted with an element in the promotional content.

In accordance with at least one embodiment of the invention, follow up VoIP calls may be initiated with recipients of promotional content to determine feedback regarding the promotional content and/or products or services associated with the promotional content. Additionally, follow up VoIP calls may be initiated, for example, when a recipient has indicated through interaction with the promotional content that he/she is interested in being contacted via VoIP regarding the subject matter of the promotional content.

In accordance with at least one embodiment of the invention, functionality may be provided for distributing promotional content in an advertising environment (such as advertising environment 100 illustrated in FIG. 1) which may include one or more networks (e.g., communication network(s) 40 illustrated in FIG. 1) which may enable free or subsidized services in exchange for users (using, e.g., VoIP clients 50, 55 or subscriber terminals 90, 95 illustrated in FIG. 1) receiving, responding to and/or interating with promotional content sent to the subscribers via VoIP or via one or more other communication networks (e.g., communication network(s) 40 illustrated in FIG. 1).

As explained above, the number of different implementations for combining IP, VoIP and cellular and PSTN technology is increasing. As a result, the number of different distribution channels for marketing also increases. As a result, in accordance with at least one embodiment of the invention, response rates to distributed promotional content may be monitored for various reasons. For example, response rates to promotional content may be used for the purposes of determining value, and as a potential result, cost to an advertiser.

Additionally, response rates may be monitored for the purpose of determining an amount or level of service provided to a subscriber when, for example, interaction with promotional content triggers receipt of free or subsidized service on one or more communication networks (any of the communication networks illustrated in FIG. 1). For example, VoIP in-network calls may be made for free or at a reduced fee as a result of a user interacting with promotional content distributed to the user. Alternatively, the cost of a monthly fee or minute-based fee may be reduced or subsidized based on a user's interaction with promotional content. Further, alternative or similar interaction-based services may be available in relation to off-network calls, i.e., when calling from a VoIP network to other networks (e.g., to other VoIP networks or PSTN or cellular network) or when users receive calls in from other networks (e.g., from other VoIPs networks or PSTN or cellular networks).

Similarly, costs for cellular phone services, VoIP services and/or PSTN services may be free or subsidized based on user interaction with distributed promotional content. Such services may include one or more voice services (i.e., making and receiving phone calls), messaging services such as SMS, MMS, using data services such as Internet browsing or WAP browsing, making video calls, downloading content, streaming content, purchasing applications such as games or other software, using location services, finding information, communicating with a group of people (e.g., multicast communication), etc.

Moreover, although not specifically illustrated or discussed above, one or more of the above-described components (e.g., AMS 20 illustrated in FIGS. 1 and 2) or additional elements may be included in the network 100 that operate or cooperate to identify a correlation between the accessing of a particular content service from a VoIP client or mobile terminal and the transmission of promotional content including a hyperlink. In such an implementation, a “click-thru” type of billing model for distributing promotional content would, therefore, be feasible. Additionally, such an implementation may also enable a business or pricing model wherein, services provided via one or more networks may be provided to a user at a reduced, free or subsidized rate.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that the VoIP PBX 70 illustrated in FIG. 1 may be replaced by or combined with an IMS server or some portion of the functionality of such a server.

Additionally, it should be understood that the term “promotional content” may include various types of advertising material including any one of or combination of text, pictures, audio, video, links to web-sites or other locations of information, telephone numbers, electronic mail addresses, downloadable files including but not limited to audio files including ring tones, songs, etc, computer implemented games, video files, etc. Also, it should be understood that the term “promotional content” includes any type of content provided in connection with mobile marketing, mobile advertising or other material provided for the purpose of persuading mobile device users.

Moreover, although various embodiment of the invention have been described herein that indicate that the transmission of messages are initiated only by subscribers via subscriber terminals such a mobile devices, it should be understood that, in accordance with at least one embodiment of the invention, at least one message may be initiated from a content service. Thus, promotional content may be included in messages sent to subscribers from content services as well as messages from subscribers. Such an implementation may have particular utility for a mobile device user when, for example, the user purchases a new mobile device and inserts the user's Subscriber Identity Module (SIM) card into the new device in connection with a paid for, free or subsidized service to which the user has subscribed.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of advertisers, advertising channel provider(s), network providers, marketing organizations, etc.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

Additionally, a history of promotional content transmitted to a particular user/subscriber may be stored and archived (e.g., in memory 215 of AMS 20 illustrated in FIG. 2). As a result, an understanding of interests of a particular user/subscriber could be gained and used to enhance relevance of promotional content transmitted to the subscriber (e.g., archived content indicates that a subscriber is interested in horror movies, is interested in foreign films, is interested in music concerts, etc.) Further, analysis of promotional content to be transmitted may be performed in whole or part using special application software running in a mobile device.

Further, it should be understood that, although the above method descriptions relate expressly to SMS and electronic mail messaging, at least one embodiment of the invention may be utilized to monitor communication network connectivity of a user following receipt and response to IM or MMS

Although the utility of various invention embodiments has been described in connection with the distribution of promotional content, it should be understood that distributed information is not limited to promotional content but may also or alternatively include non-promotional material.

As a result, it will be apparent for those skilled in the art that the illustrative embodiments described are only examples and that various modifications can be made within the scope of the invention as defined in the appended claims.

1. A system for initiating contact via a VoIP service, the system comprising:
an information management system coupled to at least one communication network; and
an interface configured to receive data indicating distribution of the content via at least one communication with at least one information recipient,
wherein the information management system is configured to monitor whether the communication has been received by the at least one information recipient, to monitor the recipient's VoIP connectivity following receipt of the communication and configured to initiate contact with the at least one recipient via VoIP when the recipient has VoIP connectivity.

2. The system of claim 1, wherein the information management system is further configured to determine when the at least one recipient has VoIP connectivity.

3. The system of claim 1, wherein the communication sent to the at least one recipient includes at least one mechanism for indicating when the communication has been received.

4. The system of claim 3, wherein the at least one mechanism is an interactive element included in the communication, which the recipient interacts with to generate a response to the communication.

5. The system of claim 3, wherein the response to the communication includes the recipient's IP address.

6. The system of claim 1, wherein the communication is a Short Messaging Service message.

7. The system of claim 1, wherein the communication is an electronic mail message.

8. The system of claim 1, wherein the communication is an Instant Messaging message.

9. The system of claim 1, wherein the communication is a Multi-Media Service message.

10. The system of claim 1, wherein the content is promotional content associated with a particular product or service.

11. The system of claim 1, wherein content includes at least one of data, text, pictures, audio, video, links to web-sites, location information, telephone numbers, electronic mail addresses, HyperText Markup Language data, eXtensible Markup Language data, eXensible HyperText Markup Language or downloadable files.

12. A system for initiating contact via a VoIP network, the system comprising:
an information management system coupled to at least one communication network; and
an interface configured to receive data indicating distribution of the content via at least one communication with at least one information recipient,
wherein the information management system is configured to monitor whether the at least one recipient has been exposed to the content of the communication; to monitor the recipient's connectivity with a VoIP network following exposure of the recipient to the content, and to contact the at least one recipient via the VoIP network when the at least one recipient is connected to the VoIP network.

13. The system of claim 12, wherein the communication sent to the at least one recipient includes at least one mechanism for indicating when the recipient has been exposed to content included in the communication.

14. The system of claim 12, wherein the contact of the at least one recipient via the VoIP network includes distribution of content to the at least one recipient via the VoIP network.

15. The system of claim 12, wherein the information management system is further configured to determine when the recipient is connected to the VoIP network based on monitoring of the recipient's connectivity.

16. The system of claim 12, wherein the at least one mechanism is an interactive element included in the communication, which the recipient interacts with to generate a response to the communication.

17. The system of claim 16, wherein the response to the communication includes the recipient's IP address.

18. The system of claim 12, wherein the communication is a Short Messaging Service message.

19. The system of claim 12, wherein the communication is an electronic mail message.

20. The system of claim 12, wherein the communication is an Instant Messaging message.

21. The system of claim 12, wherein the communication is a Multi-Media Service message.

22. The system of claim 12, wherein the content is promotional content associated with a particular product or service.

23. The system of claim 12, wherein content includes at least one of data, text, pictures, audio, video, links to web-sites, location information, telephone numbers, electronic mail addresses, HyperText Markup Language data, eXtensible Markup Language data, eXensible HyperText Markup Language or downloadable files.

24. A system for initiating contact via a VoIP network, the system comprising:
means for receiving an indication that a communication has been sent to a recipient;
means for receiving an indication that the recipient has been exposed to the communication,
means for receiving an indication of the recipient's VoIP connectivity, and
means for initiating communication with the recipient via VoIP.

25. A system for initiating contact via a VoIP service, the system comprising:
means for receiving data indicating distribution of content via at least one communication with at least one information recipient, and
means for monitoring whether the communication has been received by the at least one information recipient, monitoring the recipient's VoIP connectivity following receipt of the communication and initiating contact with the at least one recipient via VoIP when the recipient has VoIP connectivity.

26. A system for initiating contact via a VoIP network, the system comprising:
means for receiving data indicating distribution of the content via at least one communication with at least one information recipient, and
means for monitoring whether the at least one recipient has been exposed to the content of the communication; monitoring the recipient's connectivity with a VoIP network following exposure of the recipient to the content, and for contacting the at least one recipient via the VoIP network when the at least one recipient is connected to the VoIP network.

27. A method of initiating contact via a VoIP network, the method comprising:
sending a communication to at least one recipient
monitoring whether the recipient has been exposed to the content of the communication;
monitoring the recipient's connectivity with a VoIP network following exposure of the recipient to the content; and
contacting the at least one recipient via the VoIP network when the recipient is connected to the VoIP network.

28. The method of claim 27, wherein the communication sent to the at least one recipient includes at least one mechanism for indicating when the recipient has been exposed to content included in the communication.

29. The method of claim 27, wherein the contacting of the at least one recipient via the VoIP network includes distributing content to the at least one recipient via the VoIP network.

30. The method of claim 27, further comprising determining when the recipient is connected to the VoIP network based on monitoring of the recipient's connectivity.

31. The method of claim 28, wherein the at least one mechanism is an interactive element included in the communication, which the recipient interacts with to generate a response to the communication.

32. The method of claim 31, wherein the response to the communication includes the recipient's IP address.

33. The method of claim 27, wherein the communication is a Short Messaging Service message.

34. The method of claim 27, wherein the communication is an electronic mail message.

35. The method of claim 27, wherein the communication is an Instant Messaging message.

36. The method of claim 27, wherein the communication is a Multi-Media Service message.

37. The method of claim 27, wherein the content is promotional content associated with a particular product or service.

38. The method of claim 27, wherein content includes at least one of data, text, pictures, audio, video, links to web-sites, location information, telephone numbers, electronic mail addresses, HyperText Markup Language data, eXtensible Markup Language data, eXensible HyperText Markup Language or downloadable files.

39. A method of initiating contact via a VoIP service, the method comprising:
sending a communication to at least one recipient;
monitoring whether the communication has been received;
monitoring the recipient's VoIP connectivity following receipt of the communication; and
contacting the at least one recipient via VoIP when the recipient has VoIP connectivity.

40. The method of claim 39, wherein the communication sent to the at least one recipient includes the communication including at least one mechanism for indicating when the communication has been received.

41. The method of claim 39, wherein the contacting of the at least one recipient via the VoIP service includes distributing content to the at least one recipient via the VoIP service.

42. The method of claim 39, further comprising determining when the recipient has VoIP connectivity.

43. The method of claim 39, wherein the at least one mechanism is an interactive element included in the communication, which the recipient interacts with to generate a response to the communication.

44. The method of claim 43, wherein the response to the communication includes the recipient's IP address.

45. The method of claim 39, wherein the communication is a Short Messaging Service message.

46. The method of claim 39, wherein the communication is an electronic mail message.

47. The method of claim 39, wherein the communication is an Instant Messaging message.

48. The method of claim 39, wherein the communication is a Multi-Media Service message.

49. The method of claim 39, wherein the content is promotional content associated with a particular product or service.

50. The method of claim 39, wherein content includes at least one of data, text, pictures, audio, video, links to web-sites, location information, telephone numbers, electronic mail addresses, HyperText Markup Language data, eXtensible Markup Language data, eXensible HyperText Markup Language or downloadable files.
